(19) United States
(12) Patent Application Publication
(10) Pub. No.: US 2025/0286809 A1
(43) Pub. Date: Sep. 11, 2025

(54) DEVICE AND METHOD FOR DELAYING INBOUND ROUTING INFORMATION

(71) Applicant: Arista Networks, Inc., Santa Clara, CA (US)

(72) Inventors: Vipul Pravinbhai Shah, Santa Clara, CA (US); Qing Yang, Cupertino, CA (US); Andrew Xing Yuan Li, Mountain View, CA (US); Yoshihiro Ishijima, San Jose, CA (US)

(21) Appl. No.: 18/595,422

(22) Filed: Mar. 5, 2024

(51) Int. Cl. H04L 45/02; H04L 45/023; H04L 45/42

(52) U.S. Cl. CPC H04L 45/04; H04L 45/023; H04L 45/42

(57) ABSTRACT

A method of operating a network device is provided. The method can include receiving first Border Gateway Protocol (BGP) update messages from a first peer, receiving second Border Gateway Protocol (BGP) update messages from a second peer, storing routing information from the first BGP update messages in a first routing table, storing routing information from the second BGP update messages in a second routing table, and selectively delaying processing of the routing information stored in the first routing table without delaying processing of the routing information stored in the second routing table. An inbound policy configuration controller can implement a configurable amount of delay using one or more timers and one or more reject flags.

### BACKGROUND

A communication system can include multiple network devices that are interconnected to form a network for conveying packets from a source device to a destination device. Routing information indicating the route through which the packets are to be conveyed from the source device to the destination device can be shared amongst one or more peer network devices using the Border Gateway Protocol (BGP) established over corresponding Transmission Control Protocol (TCP) sessions between pairs of peer network devices.

Each network device can run a BGP process to maintain an inbound routing table or an outbound routing table and to convey routing information such as network layer reachability information (NLRI) to facilitate the use of BGP amongst its peer network devices. There can be scenarios in which a network device receives BGP routes from a first peer device, where the BGP routes received from the first peer device are dependent on BGP routes received from a second peer device. If care is not taken, prematurely processing the dependent BGP routes received from the first peer device before processing the BGP routes received from the second peer device can result in traffic loss.

### BRIEF DESCRIPTION OF THE DRAWINGS

FIG. 1 is a diagram of an illustrative networking system configured to run a Border Gateway Protocol (BGP) process in accordance with some embodiments.

FIG. 2 is a diagram of an illustrative network device configured to receive BGP update messages from two or more peer devices in accordance with some embodiments.

FIG. 3 is a diagram of an illustrative BGP update message.

FIG. 4 is a flowchart of illustrative steps for operating a network device of the type shown in FIG. 2 for selectively delaying the processing of inbound routing information in accordance with some embodiments.

FIG. 5 is a diagram showing how different groups of routes can be delayed by different amounts of time in accordance with some embodiments.

FIG. 6 is a flowchart of illustrative steps for operating a network device to selectively delay routes with different address family indicator values in accordance with some embodiments.

### DETAILED DESCRIPTION

Network devices such as switches or routers may use Border Gateway Protocol (BGP) to exchange routing information. As an example, a network device may exchange routing information using BGP with one or more peer network devices over corresponding Transmission Control Protocol (TCP) sessions. Each of these network devices may execute or run a BGP process that facilitates the reception of routing information such as network layer reachability information (NRLI) in BGP update messages from one or more peer network devices, the processing of the received routing information to determine a best routing path, and/or the transmission of the routing information in BGP update messages to one or more peer network devices. Neighboring BGP devices are sometimes referred to as “peers” or “BGP peers.”

A network device may receive first set of BGP update messages from a first peer and may receive second set of BGP update messages from a second peer. In certain situations, it may be desirable to selectively delay the processing of routing information in the first or second BGP update messages. For example, the network device can be configured to selectively delay the processing of the routing information in the first set of BGP update messages without delaying the processing of the routing information in the second set of BGP update messages. The delay in processing of the routing information in the first set of BGP update messages can be implemented by leveraging an inbound policy configuration controller. The inbound policy configuration controller can include one or more timers and one or more reject flags for marking certain routing information associated with a set of inbound BGP update messages.

To delay the processing of the routing information in the first set of BGP update messages from the first peer, the inbound policy configuration controller can start the timer when the first peer comes online, can mark the routing information associated with the first set of BGP update messages with a reject flag, can store that routing information in a corresponding inbound routing information base (RIB), and can temporarily hold that routing information in the inbound RIB for the duration of the timer. When the timer expires or when the routing information in the second set of BGP update messages from the second peer have been processed, the routing information held in the inbound RIB can be released and processed to determine a best routing path. The delay of routing information can be applied on a per peer basis, on a group of peers, or on different routes from a single peer. Operating a network device in this way can be technically advantageous and beneficial to prevent inadvertent traffic loss and to improve quality of service.

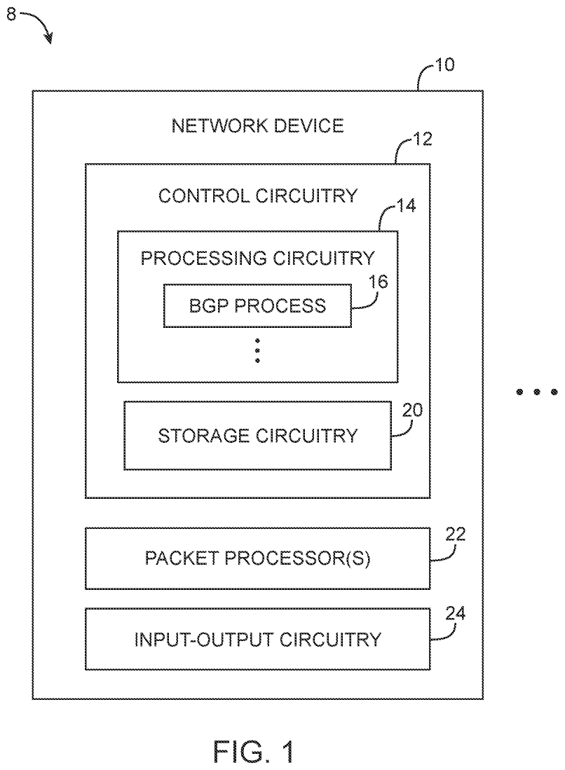

An illustrative networking system configured to provide a process for selectively delaying the processing of inbound BGP routes is shown in FIG. 1. As shown in FIG. 1, networking system 8 may include one or more network devices 10. Each network device 10 in system 8 may be a switch (e.g., a multi-layer L2/L3 switch), a router or gateway, a bridge, a hub, a repeater, a firewall, a wireless access point, a device serving other networking functions, a device that includes a combination of these functions, or other types of network devices. Multiple such network devices having the same or different networking functions in system 8 may be present and interconnected to form a communications network that processes and/or forwards traffic (e.g., data packets) between end hosts.

The communications network may be implemented with any suitable scope (e.g., as a wide area network, including one or more campus area networks or including one or more local area networks, etc.). If desired, the communications network may include internet service provider networks (e.g., the Internet) or other public service provider networks, private service provider networks (e.g., multiprotocol label switching (MPLS) networks), and/or may include other types of networks such as telecommunication service provider networks (e.g., a long-term evolution (LTE) network).

As shown in FIG. 1, network device 10 may include control circuitry 12, one or more packet processor(s) 22, and input-output circuitry 24 disposed within a housing of network device 10. Control circuitry 12 may include processing circuitry 14 and storage circuitry 20. The housing of network device 10 may include an exterior cover (e.g., a plastic exterior shell, a metal exterior shell, or an exterior shell formed from other rigid or semirigid materials) that provides structural support and protection for the components of network device 10 disposed within the housing.

Processing circuitry 14 may include one or more processors or processing units based on central processing units (CPUs), graphics processing units (GPUs), microprocessors, general-purpose processors, host processors, microcontrollers, digital signal processors, programmable logic devices such as a field programmable gate array device (FPGA), application specific system processors (ASSPs), application specific integrated circuit (ASIC) processors, and/or other types of processors. Processing circuitry 14 may run (execute) a network device operating system and/or other software/firmware that is stored on storage circuitry 20.

Storage circuitry 20 may include non-transitory (tangible) computer readable storage media configured to store the operating system software and/or any other software code, sometimes referred to as program instructions, software, data, instructions, or code. As an example, the operations described herein for selectively delaying routes as well as other network device data plane functions may be stored as (software) instructions on the non-transitory computer-readable storage media (e.g., in portion(s) of storage circuitry 20 in network device 10). The corresponding processing circuitry (e.g., one or more processors of processing circuitry 14 in network device 10) may process or execute the respective instructions to perform the corresponding operations. Storage circuitry 20 may be implemented using non-volatile memory (e.g., flash memory or other electrically-programmable read-only memory configured to form a solid-state drive), volatile memory (e.g., static or dynamic random-access memory), hard disk drive storage, and/or other storage circuitry. Storage circuitry 20 is therefore sometimes referred to as memory circuitry. Processing circuitry 14 and memory circuitry 20 as described above may sometimes be referred to collectively as control circuitry 12 (e.g., implementing a control plane of network device 10).

In particular, processing circuitry 14 may execute control plane software such as operating system software, routing policy management software, routing protocol agents or processes (e.g., one or more BGP processes such as an active BGP process 16), and other software, may be used to support the operation of protocol clients and/or servers, may be used to support the operation of packet processor(s) 22, may store packet forwarding information, may execute packet processing software, and/or may execute other software instructions that control the functions of network device 10 and the other components therein. While processing circuitry 14 is primarily described herein as executing one or more BGP processes, processing circuitry 14 may also execute one or more other network routing protocol agents or processes. As examples, these other network protocol agents may implement non-BGP distance vector routing protocols, Enhanced Interior Gateway Routing Protocol (EIGRP), Exterior Gateway Protocol (EGP), Routing Information Protocol (RIP), Open Shortest Path First (OSPF) protocol, Label Distribution Protocol (LDP), Multiprotocol Label Switching (MPLS), Intermediate System to Immediate System (IS-IS) protocol, or other Internet routing protocols (just to name a few).

Packet processor(s) 22 may be used to implement a data plane or forwarding plane of network device 10. Packet processor(s) 22 may include one or more processors or processing units based on central processing units (CPUs), graphics processing units (GPUs), microprocessors, general-purpose processors, host processors, microcontrollers, digital signal processors, programmable logic devices such as a field programmable gate array device (FPGA), application specific system processors (ASSPs), application specific integrated circuit (ASIC) processors, and/or other processor architectures.

Packet processor 22 may receive incoming data packets via input-output circuitry 24 (e.g., ports), parse and analyze the received data packets, process the packets based on packet forwarding decision data (e.g., in a forwarding information base) and/or in accordance with a network protocol, and forward (or drop) the data packet accordingly. The packet forwarding decision data may be stored on a portion of memory circuitry 20 and/or other storage circuitry integrated as part of or separate from packet processor 22.

Input-output circuitry 24 may include communication interface components such as one or more Bluetooth interface, Wi-Fi interface, Ethernet interface, optical interface, and/or other network interfaces for connecting network device 10 to the Internet, a local area network, a wide area network, a mobile network, other types of networks, and/or to another network device, peripheral devices, and/or other electronic equipment. Network device 10 may also include other components such as a system bus or connector(s) that couple the components of network device 10 to one another, power management components, thermal management components, etc.

In the example of FIG. 1, processing circuitry 14 may execute (run) a BGP process such as active BGP process 16 to exchange network routing information and network device capabilities with other network devices (sometimes referred to herein as peer network devices, peer devices, or “peers” of network device 10). Active BGP process 16 can sometimes be referred to as the primary BGP process. In particular, network device 10 may establish a TCP session with each peer and may exchange BGP messages over each of these TCP sessions with a corresponding peer network device. Use of TCP sessions to link together multiple peers in a BGP network is merely illustrative. If desired, other types of network communication links, sessions, or paths can be employed. The exchanged network routing information may be used to generate or otherwise inform the packet forwarding decision data and therefore the packet forwarding behavior of packet processor 22, among other functions.

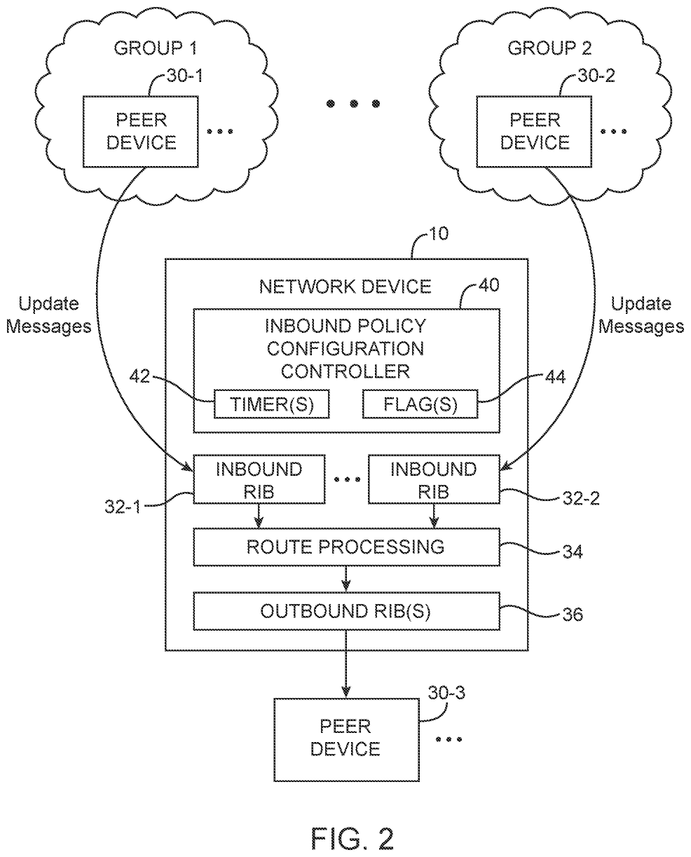

FIG. 2 is a diagram of illustrative network device 10 configured to receive BGP update messages from two or more peer devices in accordance with some embodiments. As shown in FIG. 2, network device 10 can be configured to receive a first group (set) of BGP update messages from a first peer device 30-1 and can be configured to receive a second group (set) of BGP update messages from a second peer device 30-2. Peer device 30-1 may be considered part of a first group of peers (sometimes referred to as a first peer set), whereas peer device 30-2 may be considered part of a second group of peers (sometimes referred to as a second peer set). In other embodiments, peer device 30-1 and peer device 30-2 may be considered part of the same group of peers (e.g., peers 30-1 and 30-2 can be considered part of the same peer set). Configurations in which peer device 30-1 and peer device 30-2 are part of different or distinct peer sets are sometimes described herein as an example.

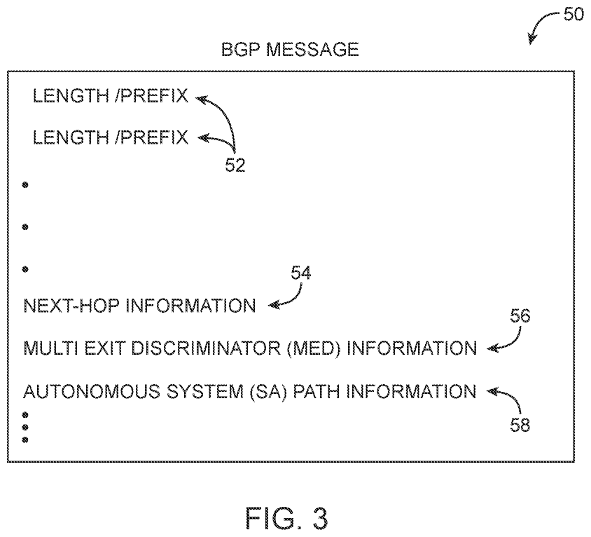

FIG. 3 is a diagram of an illustrative BGP update message 50 that can be received by device 10 from a peer network device 30 and/or that can be sent by device 10 to a peer network device 30. A BGP update message is sometimes referred to as a BGP message. As shown in FIG. 3, BGP update message 50 may include network layer reachability information (NLRI) 52 that includes one or more paths (routes) defined by corresponding sets of a length and a network prefix (e.g., 2-tuples) that are reachable by the transmitting peer network device. In particular, the length may represent a network mask (e.g., in Classless Inter-Domain Routing notation such as /8, /16, /23, /24, /25, etc.) and the prefix may represent the network address for the subnet. Each pair of a length and a network prefix defines a path or route and may sometimes be referred to herein as a path or “route” (e.g., a BGP route).

Additionally, BGP message 50 may include attributes for the routes such as next-hop information 54 (e.g., information indicative of the IP address of the border router that should be used as the next hop to the destination of the routes listed in NLRI 52), multi exit discriminator (MED) information 56 (e.g., information used to discriminate between multiple exit points to a neighboring autonomous system), autonomous system (AS) path information 58 such as a sequence of AS path segments, and/or any other paths attributes for advertisement amongst peer BGP network devices (e.g., origin information indicative of the origin of the path information, local preference information indicative of the degree of preference for an advertised route, etc.). While not explicitly illustrated in the example of FIG. 3, BGP update message 50 may also include information indicative of withdrawn routes (e.g., destinations that have become unreachable and are being withdrawn from service). Such type of information or data included within a BGP update message 50 is sometimes referred to herein collectively as “routing information,” “network routing information,” or “BGP routing information.”

Referring back to FIG. 2, network device 10 can receive the BGP update messages from the one or more peer devices 30 and can store the routing information in the update messages in one or more routing information base (RIB) 32 (see, e.g., first RIB 32-1, second RIB 32-2, etc.). A routing information base (RIB) 32 for storing the routing information of update messages received from a neighboring or adjacent peer is sometimes referred to herein as an inbound routing information base or an inbound adjacent routing information base. A routing information base 32 can also sometimes be referred to herein more generically as a routing table. The routing information associated with BGP update messages received from first peer device 30-1 may be stored in a first inbound RIB 32-1, whereas the routing information associated with BGP update messages received from second peer device 30-2 may be stored in a second inbound RIB 32-2. Update messages received from other peer devices 30 can be stored in one or more additional inbound RIBs 32. The inbound routing information can be stored in the various RIBs 32 until being processed by an active BGP process.

The routing information stored in the various RIBs 32 can be processed by an active BGP process (see, e.g., active BGP process 16 in FIG. 1), as illustrated by route processing block 34 in FIG. 2. The active BGP process may, among other functions, perform a route selection operation (sometimes referred to as a best path algorithm) by processing the received routing information stored at an inbound RIB 32, along with other inputs from other processes/agents, to identify a set of preferred routes. As part of performing route selection, the active BGP process may use at least two routes (paths) including one or more received advertised routes stored at inbound RIB 32 and/or one or more identified preferred routes to the same destination. The active BGP process may compare the different paths sharing the same destination to arrive at a preferred route to that destination. This comparison may be based on a comparison of different attributes or parameters associated with the routes being compared. As examples, the compared attributes or parameters, in order of comparison, may be the local weight of each route (e.g., with higher weights preferred), the local preference for each route, whether a route originated locally, the shortest AS_PATH (autonomous system path), origin type of each route (e.g., Exterior Gateway Protocol (EGP) preferred over Interior Gateway Protocol (IGP)), multi exit discriminator (MED) for each route (e.g., with lower MED preferred), whether each route is external BGP or internal BGP (e.g., external BGP preferred over internal BGP), IGP metric of each path (e.g., with lower IGP metric to the BGP next hop preferred), order of routes received (e.g., first received path preferred), router ID of BGP peer network device from which each path is received (e.g., with lower router ID preferred), cluster list of each route (e.g., with lower length of cluster list preferred), and neighbor address of each route (e.g., with lower neighbor address preferred). A newly identified preferred route may then be stored locally as the preferred route for the destination.

The preferred routes identified from the route processing 34 performed by the active BGP process can subsequently be stored on one or more outbound RIB(s) 36. The active BGP process can maintain the outgoing (outbound) routing information (e.g., a collection of routes) at outbound RIB 36 by storing routing information that has not yet been advertised to the peer(s) of network device 10. The active BGP process may then advertise the routing information to one or more peer device 30-3 over a corresponding TCP session. The set of peer network devices 30 that receive the advertised routing information from outbound RIB 36 may be the same or may be different from the set of peer network devices 30 transmitting the BGP update messages to the inbound RIBs 32. While the inbound RIB(s) 32 and the outbound RIB(s) 36 are sometimes shown or referred to herein as separate data structures for storing routing information, the different RIBs may (if desired) be implemented on a shared data storage structure and/or be implemented across any combination of data storage components (e.g., on storage circuitry 20 in FIG. 1). Configurations in which the inbound RIBs 32 and outbound RIB(s) 36 are stored on a shared data storage component on storage circuitry 20 are sometimes described herein as an illustrative example.

In certain scenarios, the routing information received from one peer device may depend on or be related with the routing information received from another peer device. In the illustrative arrangement of FIG. 2, the routing information in the BGP update messages received from peer device 30-1 might depend on the routing information in the BGP update messages received from peer device 30-2. As an example, the routing information associated with peer device 30-2 that is being stored at inbound RIB 32-2 may include information relating to a first number of routes, whereas the routing information associated with peer device 30-1 that is being stored at inbound RIB 32-1 may include information representing a summary of the first number of routes. In such example, the routing information being stored at inbound RIB 32-1 can sometimes be referred to as “summary” or “aggregate” routes, which can be far fewer in number than the first number of routes. In contrast, the routing information being stored at inbound RIB 32-2 contributing to the abridged summary routes stored at inbound RIB 32-1 can be referred to herein as “contributing” routes. For instance, peer device 30-2 might send BGP update messages to device 10 that advertise thousands or millions of contributing routes, whereas peer device 30-1 might send BGP update messages to device 10 that advertise only tens or hundreds of summary routes. Such numerical figures are merely exemplary. In such instance, allowing the active BGP process 16 to prematurely process the summary routes before processing the contributing routes can be problematic and can lead to traffic loss.

In accordance with some embodiments, network device 10 may leverage an inbound policy configuration control subsystem such as inbound policy configuration controller 40 to selectively delay the processing of routing information in one or more inbound RIB(s). The inbound policy configuration controller 40 may represent a mechanism for configuring inbound policies to either accept or reject received routes. The inbound policy configuration controller 40 can include one or more timer(s) 42 and can further include one or more flag(s) 44. Timer 42 can be used to set the duration of the processing delay, whereas flag 44 can be used to mark certain routes or routing information that need to be delayed. In the example above, the processing of the summary routes can be delayed until the active BGP process has finished processing all of the contributing routes.

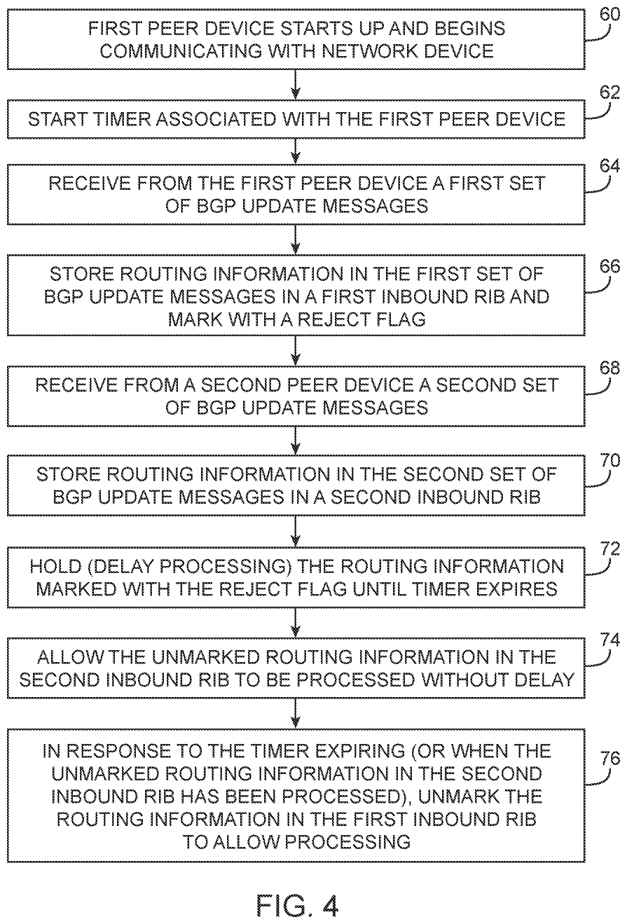

FIG. 4 is a flowchart of illustrative steps for operating network device 10 of the type described in connection with FIGS. 1-3. During the operations of block 60, a first peer network device can start up or come online. In the example of FIG. 2, first peer device 30-1 may start up and establish a connection or begin communicating with network device 10.

During the operations of block 62, inbound policy configuration controller 40 may start a timer 42 that is associated with the peer device that has just come online (i.e., peer device 30-1 in this example). The duration of timer 42 can be configurable by a user or administrator of network device 10 or can be automatically determined based on the needs or behavior of the overall system 8. As examples, the duration of timer 42 can be 1-5 minutes, less than a minute, 5-10 minutes, 10-100 minutes, 100-1000 minutes, more than 1000 minutes, a couple of hours, 1-10 hours, or more than 10 hours. The duration of timer 42 can represent a total amount of delay that device 10 must wait before processing the routing information received from peer device 30-1. Thus, the duration of timer 42 is sometimes referred to as the delay time (period), and timer 42 is sometimes referred to as a delay timer. The delay time period of delay timer 42 can be adjustable.

During the operations of block 64, network device 10 can receive from the first peer device a first set of BGP update messages. During the operations of block 66, network device 10 can be configured to store routing information in the first set of BGP update messages in a first inbound RIB (e.g., inbound RIB 32-1 in FIG. 2). The inbound policy configuration controller 40 can further mark the routing information stored in the first inbound RIB with a reject flag. Using inbound policy configuration controller 40 to mark the routing information with such flag treats all marked routes as being temporarily rejected by an inbound policy. The use of a reject flag is exemplary. If desired, other types of status indicators can also be employed to annotate a specific RIB or group(s) of routes within a particular RIB.

During the operations of block 68, network device 10 can receive from a second peer device a second set of BGP update messages. In the example of FIG. 2 network device 10 may receive a second set of BGP update messages from second peer device 30-2. During the operations of block 70, network device 10 can be configured to store routing information in the second set of BGP update messages in a second inbound RIB (e.g., inbound RIB 32-2 in FIG. 2). The example of FIG. 4 in which the operations of blocks 68 and 70 are shown as occurring after the operations of blocks 64 and 66 is illustrative. If certain scenarios, the operations of blocks 68 and 70 can occur before or in parallel (simultaneously) with the operations of blocks 64 and 66.

All routes or routing information marked with a reject flag should be held in an inbound RIB until the associated delay timer has expired. Here, the routing information stored in the first inbound RIB has been marked with a reject flag and should thus be held (or delayed) within the first inbound RIB for the delay time period (see operations of block 72). The routing information marked with such reject flag is sometimes referred to and defined herein as “marked” routes or “rejected” routes. Any such marked or rejected routes should be held (back) within the inbound RIB and prevented from being processed by a corresponding active BGP process (see, e.g., active BGP process 16 in FIG. 1 or route processing block 34 in FIG. 2). Although the operations of block 72 are shown as occurring after block 70, the operations of block 72 can start as soon as the routing information was marked as rejected during the operations of block 66. As an example, the routing information stored and being delayed in the first inbound RIB can represent summary/aggregate routes or other types of routing information that might depend on other routes (e.g., routes advertised from the second peer device).

During the operations of block 74, network device 10 can allow any unmarked routing information stored in the second inbound RIB to be processed by active BGP process 16. “Unmarked” routing information can refer to and be defined herein as routes that are not rejected by inbound policy configuration controller 40 and are thus “approved” by the inbound policy. Unmarked or approved routes can be analyzed by the active BGP process 16 without any timer delay (e.g., without having to wait for a configurable timer 42 to expire). Although the operations of block 74 are shown as occurring after block 72, the operations of block 74 can start as soon as the routing information is stored in the second inbound RIB during the operations of block 70. As an example, the routing information being processed from the second inbound RIB without delay can represent contributing routes or other types of routing information from which other routes might depend on.

In response to the delay timer expiring or optionally when the unmarked routing information has been processed by active BGP process 16 (e.g., after the active BGP process finishes processing the contributing routes), inbound policy configuration controller 40 can unmark the routing information stored in the first inbound RIB (e.g., by removing the reject flag). Removing the reject flag effectively updates the inbound policy to “accept” the associated routes, which allows those routes to be processed by the active BGP process. In other words, removing the reject flag releases the associated routing information from the inbound RIB so that the released routing information can be processed by active BGP process 16.

Selectively delaying the processing of inbound routing information in this way can be technically and advantageous to prevent the active BGP process from prematurely processing routes that might be dependent and/or interdependent on other routes, which can help minimize traffic loss while improving quality of service. The example of selectively delaying summary/aggregate routes to allow the associated contributing routes to be processed first is illustrative. In general, the techniques described herein can be employed to selectively delay one or more groups of routes that are dependent and/or interdependent on other group(s) of routes.

The operations of FIG. 4 are exemplary. In some embodiments, one or more of the described operations may be modified, replaced, or omitted. In some embodiments, one or more of the described operations may be performed in parallel. In some embodiments, additional processes may be added or inserted between the described operations. If desired, the order of certain operations may be reversed or altered and/or the timing of the described operations may be adjusted so that they occur at slightly different times. In some embodiments, the described operations may be distributed in a larger system.

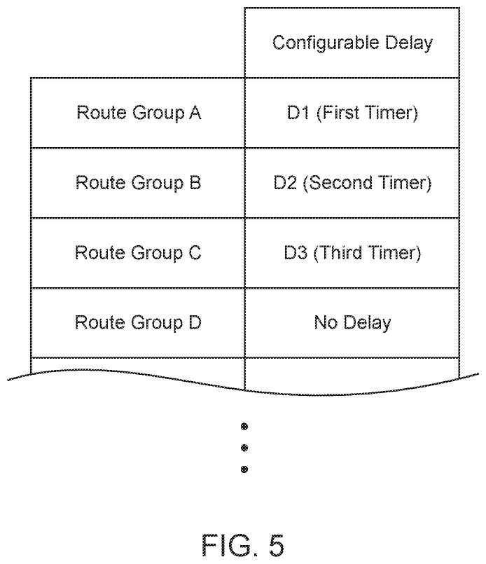

The example described in connection with FIG. 2 where inbound policy configuration controller 40 is configured to selectively delay the processing of routing information from a single peer device or peer set is illustrative. If desired, the inbound policy configuration controller 40 can be configured to provide different amounts of delay to different groups of routing information. The different groups of routes shown in FIG. 5 can correspond to routes received from different peers (e.g., to support delaying routes on a per peer basis), routes received from different peer sets (e.g., to support delaying routes on a per peer group basis), routes received from a single peer device (e.g., to support delaying routes on an intra-peer basis). As shown in FIG. 5, a first route group A can be delayed by a first delay timer amount D1; a second route group B can be delayed by a second delay timer amount D2 equal to or different than D1; a third route group C can be delayed by a third delay timer amount D3 equal to or different than D1 and D2; and a fourth route group D can have no (zero) delay (i.e., the fourth route group can be processed by the active BGP process without waiting for a timer to expire).

The routes in these different route groups can be stored in one or more inbound RIBs. As an example, routing information in the first route group A can be stored in a first inbound RIB; routing information in the second route group B can be stored in a second inbound RIB; routing information in the third route group C can be stored in a third inbound RIB; and routing information in the fourth route group D can be stored in a fourth inbound RIB. Configured in this way, different inbound RIBs can be associated with different delay timers (see, e.g., timers 42 in FIG. 2). In other embodiments, the different route groups can optionally be stored in a single inbound RIB, where different portions of the inbound RIB is assigned different delay values D1, D2, D3, etc. The example of FIG. 5 in which the inbound policy configuration controller 40 can provide different amounts of delay to four or more different groups of routes is illustrative. In general, inbound policy configuration controller 40 can be configured to provide different delays to two or more groups of routes, three or more groups of routes, four or more groups of routes, five to ten groups of routes, or more than 10 groups of routes.

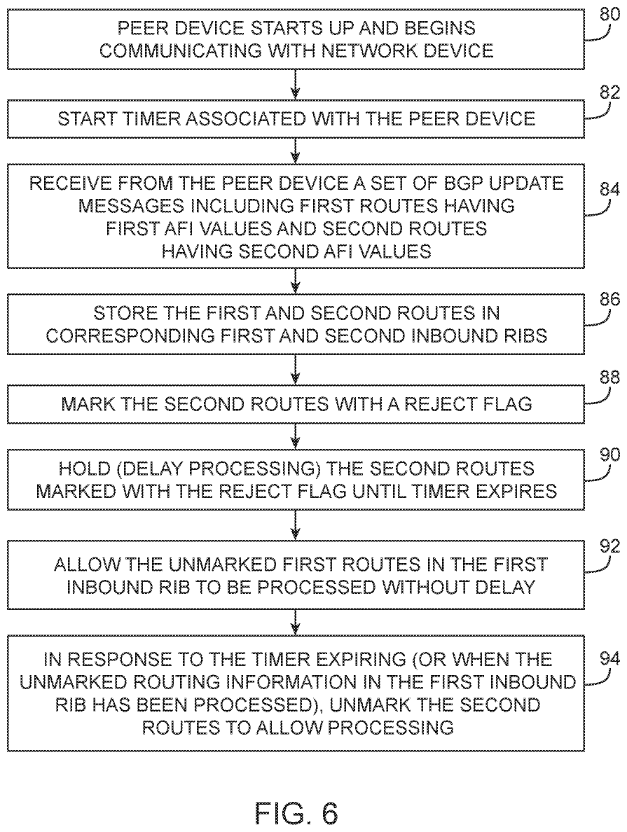

The example(s) described in connection with FIG. 4 relating to selectively delay routes from two or more peer devices are illustrative. FIG. 6 is a flowchart of illustrative steps for operating network device 10 to selectively delay routes received from a single peer. During the operations of block 80, a peer network device can start up or come online (e.g., the peer may start up and establish a connection or begin communicating with network device 10).

During the operations of block 82, inbound policy configuration controller 40 may start a timer 42 that is associated with the peer device that has just come online. The duration of timer 42 can be configurable by a user or administrator of network device 10 or can be automatically determined based on the needs or behavior of the overall system 8. As examples, the duration of timer 42 can be 1-5 minutes, less than a minute, 5-10 minutes, 10-100 minutes, 100-1000 minutes, more than 1000 minutes, a couple of hours, 1-10 hours, or more than 10 hours. The duration of timer 42 can represent a total amount of delay that device 10 must wait before processing the routing information received from the peer. The delay time period of delay timer 42 can be adjustable.

During the operations of block 84, network device 10 can receive from the peer device a set of BGP update messages. A peer device may have negotiated two or more Address Family Indicator (AFI) and Subsequent Address Family Indicator (SAFI) values. The BGP update messages can include first routes having first AFI/SAFI values and can include second routes having second AFI/SAFI values. AFI/SAFI values are sometimes referred to collectively as “address family indicator” values. AFI/SAFI values are often included as part of BGP update messages can provide additional information about the type of NLRI being advertised. For example, the AFI/SAFI values can advertise to a remote peer what address family (e.g., IPv4, IPV6, VPNv4, or VPNv6) and/or what specific sub address family (e.g., multicast or unicast) the local network device 10 will transport routes for.

During the operations of block 86, network device 10 can be configured to store the first routes in a first inbound RIB and to store the second routes in a second inbound RIB separate from the first inbound RIB.

During the operations of block 88, the inbound policy configuration controller 40 can further mark the second routes stored in the second inbound RIB with a reject flag. Using inbound policy configuration controller 40 to mark the second routes with such flag treats all marked routes as being temporarily rejected by the inbound policy.

All routes or routing information marked with a reject flag should be held in an inbound RIB until the associated delay timer has expired. Here, the second routes stored in the second inbound RIB has been marked with a reject flag and should thus be held (or delayed) within the second inbound RIB for the delay time period (see operations of block 90). Any such marked or rejected routes should be held (back) within the inbound RIB and prevented from being processed by a corresponding active BGP process (see, e.g., active BGP process 16 in FIG. 1 or route processing block 34 in FIG. 2).

During the operations of block 92, network device 10 can allow any unmarked routing information stored in the first inbound RIB to be processed by active BGP process 16. Unmarked or approved routes can be analyzed by the active BGP process 16 without any timer delay (e.g., without having to wait for a configurable timer 42 to expire). Although the operations of block 92 are shown as occurring after block 90, the operations of block 92 can start as soon as the first routes stored in the first inbound RIB during the operations of block 86.

In response to the delay timer expiring or optionally when the unmarked routing information has been processed by active BGP process 16 (e.g., after the active BGP process finishes processing the first routes with the first AFI/SAFI values), inbound policy configuration controller 40 can unmark the second routes stored in the second inbound RIB (e.g., by removing the reject flag). Removing the reject flag effectively updates the inbound policy to “accept” the associated routes, which allows those routes to be processed by the active BGP process. In other words, removing the reject flag releases the associated routing information from the inbound RIB so that the released routing information can be processed by active BGP process 16.

Selectively delaying the processing of inbound routing information in this way can be technically and advantageous to prevent the active BGP process from prematurely processing routes that might be dependent and/or interdependent on other routes, which can help minimize traffic loss while improving quality of service. The example of selectively delaying routes with different AFI/SAFI values is illustrative. In general, the techniques described herein can be employed to selectively delay one or more groups of routes with different autonomous system path values, next hop values, multi-exit discrimination (MED) values, community values, prefix length values, and/or other BGP or routing parameters.

The operations of FIG. 6 are exemplary. In some embodiments, one or more of the described operations may be modified, replaced, or omitted. In some embodiments, one or more of the described operations may be performed in parallel. In some embodiments, additional processes may be added or inserted between the described operations. If desired, the order of certain operations may be reversed or altered and/or the timing of the described operations may be adjusted so that they occur at slightly different times. If desired, the techniques described herein need not be limited to BGP and can be extended to other networking protocols.

In some embodiments, the described operations may be distributed in or included within a larger system. Such system may be part of a digital system or a hybrid system that includes both digital and analog subsystems. Network device 10 may be included as part of a system employed in a wide variety of applications as part of a larger computing system, which may include but is not limited to: a datacenter, a financial system, an e-commerce system, a web hosting system, a social media system, a healthcare/hospital system, a computer networking system, a data networking system, a digital signal processing system, an energy/utility management system, an industrial automation system, a supply chain management system, a customer relationship management system, a graphics processing system, a video processing system, a computer vision processing system, a cellular base station, a virtual reality or augmented reality system, a network functions virtualization platform, an artificial neural network, an autonomous driving system, a combination of at least some of these systems, and/or other suitable types of computing systems.

The methods and operations described above in connection with FIGS. 1-6 may be performed by the components of one or more network device(s) using software, firmware, and/or hardware (e.g., dedicated circuitry or hardware). Software code for performing these operations may be stored on non-transitory computer readable storage media (e.g., tangible computer readable storage media) stored on one or more of the components of the network device. The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of the network device (e.g., using processing circuitry 14 of FIG. 1).

The foregoing is merely illustrative and various modifications can be made to the described embodiments. The foregoing embodiments may be implemented individually or in any combination.

What is claimed is:

1. A method of operating a network device comprising:
receiving first Border Gateway Protocol (BGP) update messages from a first peer device;
receiving second Border Gateway Protocol (BGP) update messages from a second peer device;
storing routing information from the first BGP update messages in a first inbound routing information base (RIB);
storing routing information from the second BGP update messages in a second inbound routing information base (RIB); and
delaying processing of the routing information stored in the first inbound RIB.

2. The method of claim 1, wherein delaying the processing of the routing information stored in the first inbound RIB comprises delaying the processing of the routing information stored in the first inbound RIB without delaying processing of the routing information stored in the second inbound RIB.

3. The method of claim 1, further comprising:
in response to the first peer device establishing a connection with the network device, starting a timer configured to provide a duration by which the processing of the routing information stored in the first inbound RIB is being delayed.

4. The method of claim 3, wherein the duration of the timer is configurable.

5. The method of claim 3, further comprising:
marking the routing information stored in the first inbound RIB with a reject flag.

6. The method of claim 5, further comprising:
allowing processing, by an active BGP process, of the routing information stored in the second inbound RIB while the routing information stored in the first inbound RIB is marked with the reject flag.

7. The method 6, further comprising:
in response to the timer expiring, unmarking the routing information stored in the first inbound RIB by removing the reject flag and releasing the unmarked routing information from the first inbound RIB so that the unmarked routing information is processed by the active BGP process.

8. The method 6, further comprising:
in response to the active BGP process having finished processing the routing information stored in the second inbound RIB, unmarking the routing information stored in the first inbound RIB by removing the reject flag and releasing the unmarked routing information from the first inbound RIB so that the unmarked routing information is processed by the active BGP process.

9. The method of claim 1, further comprising:
receiving the first BGP update messages from the first peer device before receiving the second BGP update messages from the second peer device.

10. The method of claim 1, further comprising:
receiving the second BGP update messages from the second peer device before receiving the first BGP update messages from the first peer device.

11. A method of operating a network device comprising:
receiving Border Gateway Protocol (BGP) update messages from a peer device;
storing a first portion of the BGP update messages received from the peer device in a first inbound routing information base (RIB);
storing a second portion, different than the first portion, of the BGP update messages received from the peer device in a second inbound routing information base (RIB); and
delaying processing of the second portion of the BGP update messages stored in the second inbound RIB without delaying processing of the first portion of the BGP messages stored in the first inbound RIB.

12. The method of claim 11, wherein the first portion of the BGP update messages comprises first routes associated with first address family indicator values, and wherein the second portion of the BGP update messages comprises second routes associated with second address family indicator values different than the first address family indicator values.

13. The method of claim 12, further comprising:
in response to the peer device establishing a connection with the network device, starting an adjustable timer configured to provide a delay duration by which the processing of the second routes stored in the second inbound RIB is being delayed.

14. The method of claim 13, further comprising:
marking the second routes stored in the second inbound RIB with a reject flag to prevent the second routes from being processed by an active BGP process; and
allowing processing, by the active BGP process, of the first routes stored in the first inbound RIB while the second routes stored in the second inbound RIB are marked with the reject flag.

15. The method 14, further comprising:
in response to the timer expiring or in response to the active BGP process having finished processing the first routes stored in the first inbound RIB, unmarking the second routes stored in the second inbound RIB by removing the reject flag and releasing the unmarked second routes from the second inbound RIB so that the unmarked second routes can be processed by the active BGP process.

16. A method of operating a network device comprising:
receiving routing information from one or more neighboring network devices;
storing the received routing information in one or more routing tables; and
selectively delaying processing of a first portion of the routing information stored in the one or more routing tables while processing a second portion, different than the first portion, of the routing information stored in the one or more routing tables without delay.

17. The method of claim 16, wherein the processing of the first portion of the routing information is delayed by a first delay amount, the method further comprising:
selectively delaying processing of a third portion of the routing information stored in the one or more routing tables by a second delay amount different than the first delay amount.

18. The method of claim 17, further comprising:
selectively delaying processing of a fourth portion of the routing information stored in the one or more routing tables by a third delay amount different than the first and second delay amounts.

19. The method of claim 16, further comprising:
with an inbound policy configuration controller, marking the first portion of the routing information stored in the one or more routing tables with a flag.

20. The method of claim 16, further comprising:
communicating with the one or more neighboring network devices via Border Gateway Protocol (BGP).
